(19) United States
(12) Patent Application Publication
(10) Pub. No.: US 2018/0268503 A1
(43) Pub. Date: Sep. 20, 2018

(54) SYSTEM AND METHOD FOR SELECTIVE CHOICE

(71) Applicants: Manav C. PARIKH, Wallingford, CT (US); Chirag R. PARIKH, Wallingford, CT (US); Ronak R. PARIKH, Edison, NJ (US)

(72) Inventors: Manav C. PARIKH, Wallingford, CT (US); Chirag R. PARIKH, Wallingford, CT (US); Ronak R. PARIKH, Edison, NJ (US)

(21) Appl. No.: 15/922,812

(22) Filed: Mar. 15, 2018

Related U.S. Application Data
(60) Provisional application No. 62/471,698, filed on Mar. 15, 2017.

(51) Int. Cl. G06Q 50/12; G06K 19/06; G06Q 30/06; G06K 7/14

(52) U.S. Cl. CPC G06Q 50/12; G06K 7/1417; G06Q 30/0627; G06K 19/06037

(57) ABSTRACT

A personalized QR or other machine-readable code is presented by a user at an establishment where a selection of items is presented to users. In a preferred embodiment the machine-readable code is printed on or attached to a wearable accessory such as a bracelet or necklace, but could also be carried on a card, for example. The personalized QR code is created based on a person's individual preferences or restrictions. In the food/restaurant example, it is personalized based on the person's allergens. The establishment is provided with a device configured to read the QR code presented by the user and process the individual preferences so as to only present to the user a list of a subset of the available items, all of which meet the user's preferences and/or restriction requirements.

### CROSS-REFERENCE TO RELATED APPLICATIONS

This application is based on, and claims priority to U.S. Provisional Application No. 62/471,698, filed on Mar. 15, 2017, the entire contents of which is fully incorporated herein by reference.

This invention is directed to a method and system for providing selective choice to a user based on predetermined and/or preselected characteristics (e.g., restrictions or preferences) of interest directed to a subset of a complete body of choices of items, and in an embodiment, to a method and system for providing selective choice to people with food allergies, food intolerances, and dietary restrictions. The invention can find use in any situation or environment where there are a large body of choices of anything (food, pharmaceuticals, materials, clothing, colors, etc.) and where a particular user or consumer of these things may have restrictions or preferences directed to a subset of the complete body of choices. In this application the discussion focuses on food choices and allergies, but it is understood that this is for purpose of example and is not intended to limit the invention to only this option.

### BACKGROUND

A purpose of an exemplary embodiment of the invention described herein is to make eating in restaurants a safe, enjoyable and relaxing experience for people with allergies. As discussed on the FARE (Food Allergy Research and Education) website:
According to a study released in 2013 by the CDC, food allergies among children increased approximately 50% between 1997 and 2011.
Approximately 15,000,000 Americans have food based allergies.
Food allergies result in more than 300,000 urgent care visits a year among children under the age of 18.
Food allergies can have varying ranges of severity, but 1 in 13 children (or about 2 in every standard classroom), are affected by food allergies.
Teenagers and young adults with food allergies are at the highest risk of fatal food-induced anaphylaxis.
Eating away from home can pose a significant risk to people affected by food allergies. Research suggests that close to half of fatal food allergy reactions are triggered by food consumed outside the home.
One study looking at peanut and tree nut allergy reactions in restaurants and other food establishments found that the food establishment was often not properly notified of a food allergy by the customer with the allergy.

In 2016, approximately 231 million people in the U.S. visited some type of food establishment where food could be ordered. Restaurants provide menus for food, and some menus are even provided electronically, e.g., via digital tablet devices. See, for example APTITO digital menus provided by Aptito of North Miami Beach, Fla. A problem exists, however, for persons with food allergies, as most menus do not specify the allergens contained in each dish. Thus, many people with allergies do not have a way of knowing which dishes contains their allergens when looking at a menu, so they have a difficult time ordering food and need to ask the waiter which dishes contain specific allergens. Further, the few menus that do provide information on allergens require the diner to notice the allergen information and comb through the entire menu looking for menu choices that do not contain the particular allergens of concern, which can be missed unless the diner is being very attentive.

Nowadays, people often have unusual allergies (i.e. an allergy to quinoa) or multiple allergies (i.e. dairy, eggs and soy), so the question may not be as simple as asking which dishes are nut-free or dairy-free, for example. Because there are 8 common allergens, but over 80 known allergens, a restaurant waiter cannot be expected to know the allergens (and all possible combinations) in every menu item.

Usually after the customer tells the waiter about his or her specific allergies, the waiter then needs to check or confirm with the kitchen about a specific dish. Once the waiter comes back with the answer, the customer feels like they have to make an on-the-spot decision, so they don't delay the order for the rest of their table. Sometimes the customer may have a follow-up question when the waiter comes back with an answer about a specific dish and sometimes the waiters may get annoyed because it is busy and they don't have time to go to the kitchen multiple times to ask questions. This back and forth is inefficient for the waiter, the restaurant, and the customer and the whole process can be uncomfortable for the customer.

It would be desirable to have a method and system whereby customers with allergies could have their allergen-free menu options presented to them immediately, like other customers, when they look at restaurant menus. This would give customers with allergies time to think about and discuss what they want to order when everyone else at their table is doing the same, rather than trying to figure out which menu choices might contain their allergens. It would also avoid the back and forth with the waiter, and alert the waiter and the restaurant that they are serving food to someone with allergies, so they should also be extra careful with contamination when preparing the food. Such a method and system would allow going out to eat to be a relaxing and fun experience and the present invention helps make sure that people with allergies have the same positive experience as people without allergies.

### SUMMARY OF THE INVENTION

The invention includes a personalized QR or other machine-readable code presented by a user at an establishment where a selection of items is presented to users. In a preferred embodiment the machine-readable code is printed on or attached to a wearable accessory such as a bracelet or necklace, but could also be carried on a card, for example. The personalized QR code is created based on a person's individual preferences or restrictions. In the food/restaurant example, it is personalized based on the person's allergens. The establishment is provided with a device (e.g., a POS terminal, a tablet device, a smart-phone) configured to read the QR code presented by the user and process the individual preferences so as to only present to the user a list of a subset of the available items, all of which meet the user's preferences and/or restriction requirements. In the restaurant example, the user would be presented with a “truncated menu” which displays to the user only those food choices that do not contain the user's allergens.

### BRIEF DESCRIPTION OF THE DRAWINGS

FIG. 1 shows prototypes of the present claimed invention showing examples of QR codes on bracelets and necklaces;

FIG. 2 illustrates a typical online-menu for a well-known restaurant;

FIG. 3 shows the menu list of FIG. 2 that has been reduced from 118 available items to just 26 using the present invention; and

FIG. 4 is a diagram showing the general process of the present invention.

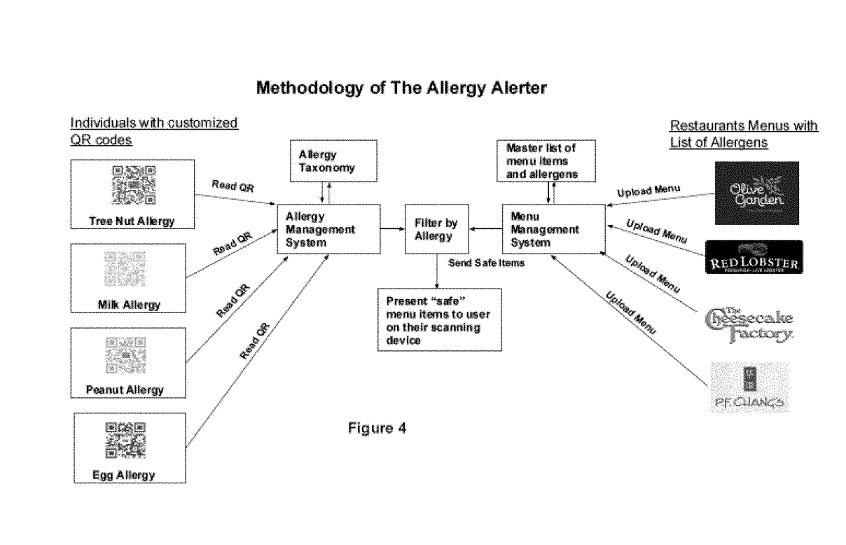

### DETAILED DESCRIPTION OF AN EMBODIMENT

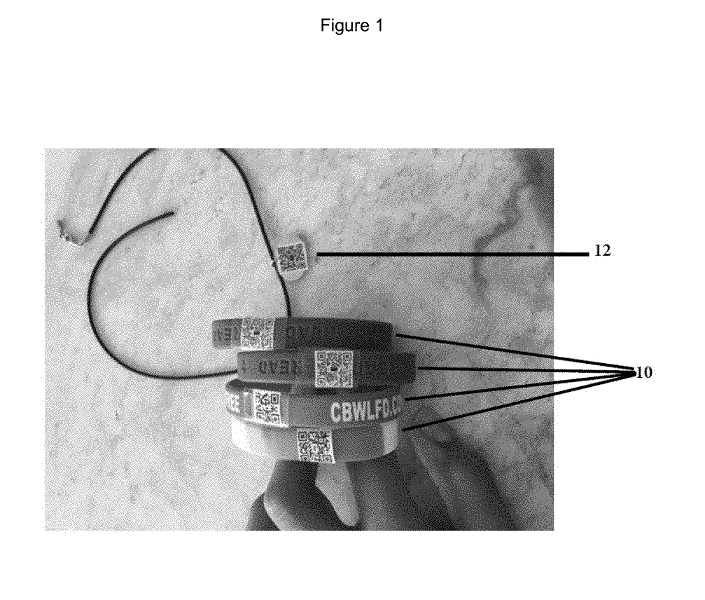

An embodiment directed to a food and allergen application is described in connection with the attached Figures. FIG. 1 illustrates some wearable bracelets 10 and a necklace 12 that have been fitted with personalized QR codes according to the invention. Applicant made the QR codes using a website called UNITAG, although any method of creating a QR code maybe used. Using UNITAG, Applicant entered a series of different allergens in the text box on the site, identifying certain allergens that a hypothetical user might have. Each QR code identifies a particular allergen, such as peanuts, tree-nuts, milk, gluten, etc., or a combination of allergens (e.g., all of soy, dairy and eggs). In the prototypes shown in FIG. 1, Applicant printed and cut out the personalized QR codes and attached them to rubber bracelets/bands using clear tape. Applicant used the same principal and attached a QR code on a pendant for a necklace. The clear tape allows the QR code to be viewed and thus scanned through the tape while also keeping it affixed to the wearable item. It is understood that this method was used for the purpose of creating prototypes and that many other options are available when making production models, with no limitations on the type of wearable accessory that is to be used and with options other than clear tape for adhering the QR codes (for example the QR codes could be directly printed onto a wearable accessory, a wallet-card, or the like).

A second element of the invention is embodied in a QR reader device that includes, or can be coupled to, a menu display device. In a preferred embodiment the QR reader and menu display device comprise a single device, such as a smartphone or tablet device, both of which typically can include QR reader capability. For simplicity a tablet device is discussed herein. The tablet includes processors to receive, store, and process data retrieved via the QR reader, as well as data stored in memory of the tablet itself. As is well-known, the tablet may also be connected via wired or wireless connectivity to a network where data may be accessed, processed, retrieved, and/or stored.

The tablet is configured using known programming techniques to receive the data from the QR code being worn or presented by the user, and from a list of all menu items available at the particular establishment where the tablet is being used, filter out all menu items containing the customer's allergens, and then display in the tablet only those menu items from the filtered list Typically this occurs using the camera of the table to other device to capture an image of the QR code, and then QR code processing software processes the QR code to identify and read the data from the QR code. In this example, data would relate to the allergies of the user.

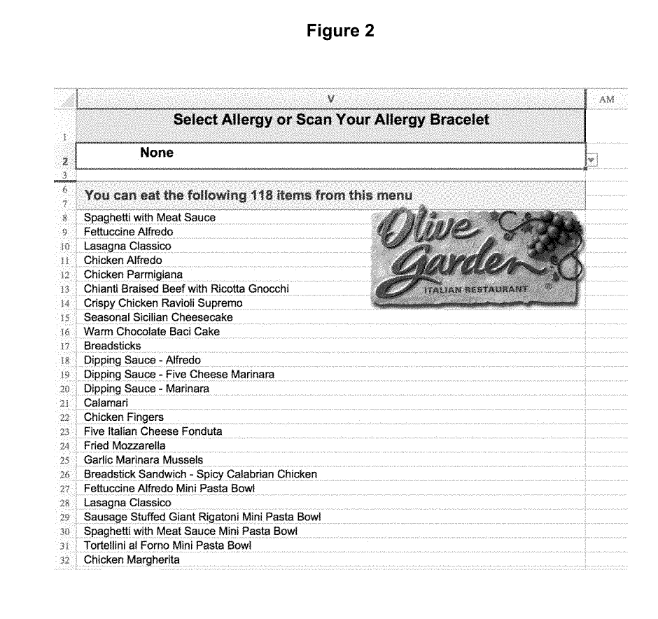

FIG. 2 illustrates a typical online-menu for the well-known OLIVE GARDEN restaurant. This is used just for purpose of example only, to show that a list of 118 menu items are available for a person with no food allergies (“You can eat the following 118 items from this menu”). The 118 menu items are stored in a central database of the restaurant accessible via the tablets and/or can be stored on each individual tablet at the restaurant. The data for each menu item is characterized by its ingredients and each known allergen for each menu item is mapped to and associated with the menu item, so that the allergens contained in each menu item can be identified. Presume that a user presents a QR code indicating that he or she is allergic to dairy products. The user scans the QR code into the tablet where it identifies the user as having a dairy allergy.

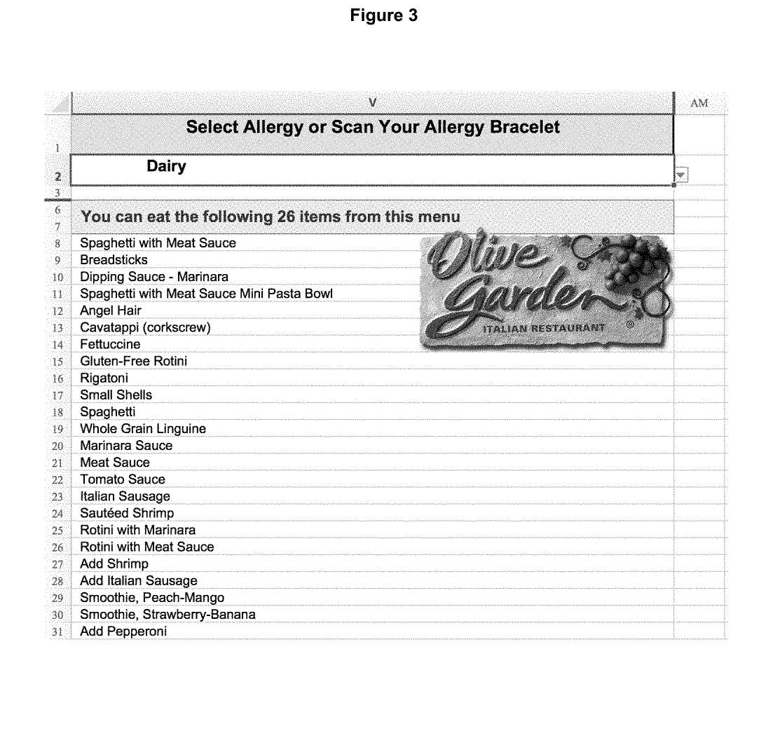

The processors of the tablet are configured to identify each menu item that contains dairy and filter out all such menu items and display the rest on the tablet in a menu-style format. In this manner, the user is presented, in real time and without having to make any inquiries, a menu list of all menu items that do not contain dairy. As can be seen in FIG. 3, the menu list of FIG. 2 has been reduced from 118 available items to just 26 (“You can eat the following 26 items from this menu”). The truncated menu can be displayed on the tablet, or a smartphone, or any means of displaying the truncated menu, including a printed copy if the menu display device includes printing capability.

As described above, in use, people with an allergy or a combination of allergies would wear a bracelet/necklace or keep with them anything that can have attached or printed on it a personalized QR code which contains their specific allergies. The QR code will be customized onto one bracelet even for combination allergies. When the person goes to a restaurant, the waiter scans the QR code on the bracelet with a scanner on the restaurant's electronic device—it can be a phone or a tablet, for example. The device is programmed to correspond with the restaurant's menu and to filter out the menu items containing the specific allergen(s) scanned by the QR code. The customer and the waiter can now look at the new “customized” menu on the restaurant's device to see the remaining menu items that the customer can safely choose from. Also, the waiter is now aware of the customer's allergies, so they can alert the kitchen to be extra careful when preparing that customer's dish to avoid cross-contamination with his or her allergens.

Other embodiments are contemplated in accordance with the invention. For example, because the system can use tablets, smartphones, and the like to be implemented, they can include the following:

It can be location aware, since most tablets, smartphones, and other handheld devices have location-aware capability, so the devices can be configured to automatically identify the restaurant or eating establishment where the individual is present.

Machine learning algorithms can be configured into the tablet to other device, to allow continuous improvement of recommendations using artificial intelligence models. Since there will be available allergy information and preference information from every user, the machine learning algorithm can learn menu items preferred and not preferred by other users with similar preferences and allergies.

The present system is personalized, since there will be available a taxonomy of allergy and menu items and user's allergies, so the matching engine will produce personalized recommendations based on location, personal preference and learning from other with similar allergy and preferences.

The system will also be able to prevent allergic reactions to substances with related chemical or biological properties to primary allergens. Individuals who are allergic to one compound could also be allergic to other substances which are related chemically or biologically to the primary compound. Frequently, the individual is not aware of the related allergens as they have not been exposed to them. Based on the currently available scientific data and data from the other users with multiple allergies, the present invention can be configures to warn the individual about foods that could be potentially allergic. For example, conceptually, the percent identity of the amino acid sequence between aligned proteins provides a comparison that has been historically discussed in evaluating proteins that are clinically cross-reactive or that share IgE binding properties. See Aalberse, R. C. (2000), Structural biology of allergens, J. Allergy Clin. Immunol. 106:228-238 where potentially cross-reactive structures of known allergens are reviewed and it is noted that proteins with greater than 70% identical primary amino acid sequences throughout the length of the protein, compared to an allergen are commonly cross-reactive, while those with less than 50% identity are unlikely to be cross-reactive. There are some allergen databases available which can be harnessed which can be utilized to perform a search with every possible 80 amino acid segment of the query protein with all the other proteins in the database. An example of one such database is AllergenOnline which allows individualized query and provide output with a probability of cross-reactivity with other foods in the database.

Some examples of cross-reactivity include: 1. peanut allergy with allergies to legumes, seeds fruit and pollen. 2. Birch and pollen food syndrome 3. Cross reactivity has been described between different mammalian milks and between milk and meat or animal dander.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, CD, DVD, or any other known non-transitory storage element. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A method of selectively truncating a processor-implemented listing of a complete body of choices of items stored on a processor, comprising:
inputting, to said processor, data identifying one or more characteristics of interest related to said items;
using said processor, identifying any items in said complete body of choices that do not possess said characteristics of interest; and
displaying, on an electronic display device, a truncated version of said complete body of choices of items, wherein said display device displays only choices of items that do not possess the characteristics of interest.

2. The method of claim 1, wherein said complete body of choices of items comprises items on a restaurant menu.

3. The method of claim 2, wherein said data identifying one or more characteristics of interest comprises data pertaining to ingredients contained in said items on a restaurant menu.

4. The method of claim 3, further comprising the steps of:
using said processor, identifying any items on said restaurant menu that do not contain ingredients falling within said identified one or more characteristics of interest; and
displaying, on an electronic display device, a truncated version of said restaurant menu comprising a listing of said identified items.

5. The method of claim 4, wherein said processor is configured to read QR codes, and wherein said inputting of data is performed by:
creating a readable QR code identifying the one or more categories of ingredients of interest;
printing said readable QR code on an object that can be carried by a user;
presenting said object to said processor for reading, thereby inputting said data to said processor; and
processing said input data to create said truncated version of said restaurant menu.

6. The method of claim 5, wherein said object comprises a wearable object.

7. The method of claim 6, wherein said wearable object comprises jewelry.

8. The method of claim 6, wherein said wearable object comprises a wristband.

9. The method of claim 5, wherein said wearable object comprises a wallet-sized card.
